(19) United States
(12) Patent Application Publication
(10) Pub. No.: US 2022/0062753 A1
(43) Pub. Date: Mar. 3, 2022

(54) FRONT SIGHT MOVEMENT CONTROL METHOD, DEVICE AND STORAGE MEDIUM FOR SHOOTING GAMES

(71) Applicant: Yun SHEN, Zhuzhou (CN)

(72) Inventor: Yun SHEN, Zhuzhou (CN)

(21) Appl. No.: 17/463,712

(22) Filed: Sep. 1, 2021

(30) Foreign Application Priority Data
Sep. 2, 2020 (CN) 202010910471.1

(51) Int. Cl. A63F 13/213; A63F 13/837; A63F 13/219

(52) U.S. Cl. CPC A63F 13/213; A63F 2300/8076; A63F 13/219; A63F 13/837

(57) ABSTRACT

A front sight movement control method, device and storage medium for shooting games, having the following steps. S100: Get the image frame corresponding to the muzzle aiming position. If there is a first coordinate, determine whether there is a positioning spot in the said image frame and proceed to S100 if not or take it as a first coordinate and proceed to S100 if yes. If there is a first coordinate, determine whether there is a positioning spot in the said image frame and delete a first coordinate and proceed to S100 if not, or take it as a second coordinate if yes. S300: Get an offset value as a movement value of a front sight. S400: Replace a first coordinate with a second coordinate, and proceed to S100. This method can realize the target aiming through moving the gun muzzle, which enhances the sense of immersion and novelty that the user feels when playing a shooting game.

### FIELD OF THE INVENTION

This invention relates to the technical field of game equipment, to be specific, relates to the front sight movement control method, device and storage medium for shooting games.

### BRIEF SUMMARY OF THE RELATED ART

Currently, players usually aim and shoot at the target using gamepads, mice, keyboards and the like in shooting games (centered front sight type), and the gamepad is neither suitable for shooting games for new players, nor a good choice to provide good user experience due to the problem of aiming inaccuracy.

### SUMMARY OF THE INVENTION

The front sight movement control method, device and storage medium for shooting games in the present invention can realize the target aiming through moving the gun muzzle, which enhances the sense of immersion and novelty that the user feels when playing a shooting game.

The front sight movement control method disclosed in this invention for shooting games uses the following technical scheme:

A front sight movement control method for shooting games comprises the following steps: S100: Obtain the image frame corresponding to the muzzle aiming position; S200: Determine whether there is a first coordinate (X1, Y1): if not, scan the pixel point of the said image frame to determine whether there is at least one positioning spot in the frame; If there is no positioning spot, proceed to S100; If positioning spot exists, record the coordinate of the positioning spot in the image frame as the first coordinate (X1, Y1) and proceed to S100; If there is a first coordinate (X1, Y1), scan the pixel point of the said image frame to determine whether there is a positioning spot in the image frame; If not, delete the first coordinate (X1, Y1), then proceed to S100; If yes, record the pixel point coordinate of the positioning spot in the image frame as the second coordinate (X2, Y2); S300: Obtain the offset value (X2−X1, Y2−Y1) between the first coordinate (X1, Y1) and the second coordinate (X2, Y2) and take such offset value (X2−X1, Y2−Y1) as the movement value of the front sight; S400: Replace the first coordinate (X1, Y1) with the second coordinate (X2, Y2) and then proceed to S100.

As an optimal option, if there is a first coordinate (X1, Y1) in the said scope, the following steps shall be used to scan pixel points in the said image frame to determine whether there is a positioning spot in the frame: If there is a first coordinate (X1, Y1), make a localized scan over the pixel points of the image frame within the preset area around the first coordinate (X1, Y1) to determine whether there is a positioning spot in the preset area.

As an optimal option, if there is no positioning spot in the said scope, the following steps shall be used to delete the first coordinate (X1, Y1) and proceed to S100: If there does not exist a positioning spot, scan all the pixel points in the image frame to determine whether there is a positioning spot in the whole area; If not, delete the first coordinate (X1, Y1) and then proceed to S100; If yes, delete the first coordinate (X1, Y1), record the pixel point coordinate of the positioning spot in the image frame as the first coordinate (X1, Y1) and then proceed to S100.

As an optimal option, the following steps shall be used to determine whether there is a positioning spot in the preset scope: Obtain the grey level of pixel point in the preset area of the image frame: Determine whether there are multiple continuous pixel points having grey levels higher than the preset one; If yes, take the continuous pixel points as positioning spots.

As an optimal option, if there is no first coordinate (X1, Y1) in the said scope, the following steps shall be used to scan pixel points in the said image frame to determine whether there is at least one positioning spot in the frame: Obtain the grey level of pixel point in the image frame: Determine whether there are multiple continuous pixel points having grey levels higher than the preset one; If yes, take the continuous pixel points as positioning spots.

As an optimal option, if there is a positioning spot in the said scope, the following steps shall be used to record the coordinate of the pixel point of positioning spot in the image frame as the first coordinate (X1, Y1): Identify the central pixel point among multiple continuous pixel points: Obtain the coordinate of the central pixel point and take it as the first coordinate (X1, Y1).

As an optimal option, the following steps shall be used to obtain the coordinate of the central pixel point as the first coordinate (X1, Y1): Determine whether there is only one central pixel point: If yes, obtain the coordinate and take it as the first coordinate (X1, Y1); If not, obtain the coordinates of the multiple central pixel points respectively: Obtain the coordinate of the pixel point nearest to the center of the image frame and take it as the first coordinate (X1, Y1).

As an optimal option, if there is no positioning spot in the said scope, the following steps shall be used after proceeding to S100: Output the revision information of the muzzle aiming position.

This proposal also presents a front sight movement control device for shooting games that comprises: A transmitting terminal including the gun body, and the processing unit and wireless transmitting unit installed on the gun body, with camera installed on the gun muzzle for obtaining the image frame of the aiming position and output the frame to the processing unit; the said processing unit stores and executes computer program in order to perform the above-mentioned front sight movement control methods; the said wireless transmitting unit is used output the movement value of the front sight.

As an optimal option, it also comprises: Receiving terminal, including a receiver and at least one infrared positioning light to produce positioning spot on the image frame received by the camera by transmitting infrared rays, and the said receiver has a wireless receiving unit for receiving movement value of the front sight and output the value to the game console through the receiver.

This proposal also presents a storage medium that stores and executes computer program, which, while being executed by the processing unit, will perform the above-mentioned front sight movement control methods.

The positive effect of the embodiment of this disclosed invention includes: Obtain the image frame corresponding to the muzzle aiming position to determine whether there is a first coordinate (X1, Y1), that is, whether the reference coordinate exists. If not, scan the pixel point of the said image frame to determine whether there is at least one positioning spot in the image frame. If yes, record the coordinate of the pixel point of the positioning spot in the image frame as the first coordinate (X1, Y1), namely the reference coordinate and then back to S100. If not, proceed to S100 to obtain the first coordinate (X1, Y1) again as the reference coordinate. If the first coordinate (X1, Y1), namely the reference coordinate exists, scan the pixel point of the said image frame to determine whether there is a positioning spot in the image frame. If the positioning spot exists, record the coordinate of the pixel point of the positioning spot in the image frame as the second coordinate (X2, Y2) to obtain the moving coordinate, and then obtain the offset value (X2−X1, Y2−Y1) between the first coordinate (X1, Y1) and the second coordinate (X2, Y2). The offset value (X2−X1, Y2−Y1), namely the absolute movement value between the moving coordinate and the reference coordinate, could be used to obtain the movement value of the mouse (and the front sight), and then improve the sense of immersion and novelty of shooting games for users by aiming at the target through muzzle movement. The absence of positioning spot means the non-existence of moving coordinate and the unavailability of the absolute movement value between the moving coordinate and the reference coordinate, in this case, delete the first coordinate (X1, Y1) and then proceed to S100 to obtain the reference coordinate. At last, replace the first coordinate (X1, Y1) with the second coordinate (X2, Y2), proceed to S100, that is, take the moving coordinate as the reference coordinate, then obtain the new moving coordinate to get the absolute movement value between the new moving coordinate and the reference coordinate to ultimately realize continuous movement of front sight in the game.

### BRIEF DESCRIPTION OF THE DRAWINGS

FIG. 1 is the schematic flow chart of the front sight movement control method for shooting games in this invention.

FIG. 2 is the schematic of image frame scanning of the front sight movement control method for shooting games in this invention.

FIG. 3 shows another execution procedure of the front sight movement control method for shooting games in this invention.

FIG. 4 shows another execution procedure of the front sight movement control method for shooting games in this invention.

FIG. 5 shows another execution procedure of the front sight movement control method for shooting games in this invention.

FIG. 6 shows another execution procedure of the front sight movement control method for shooting games in this invention.

FIG. 7 shows another execution procedure of the front sight movement control method for shooting games in this invention.

FIG. 8 is the structural schematic of the front sight movement control device for shooting games in this invention.

### DETAILED DESCRIPTION OF THE PREFERRED EMBODIMENTS

The invention will be further interpreted and illustrated with the following embodiments and instruction-attached illustrations:

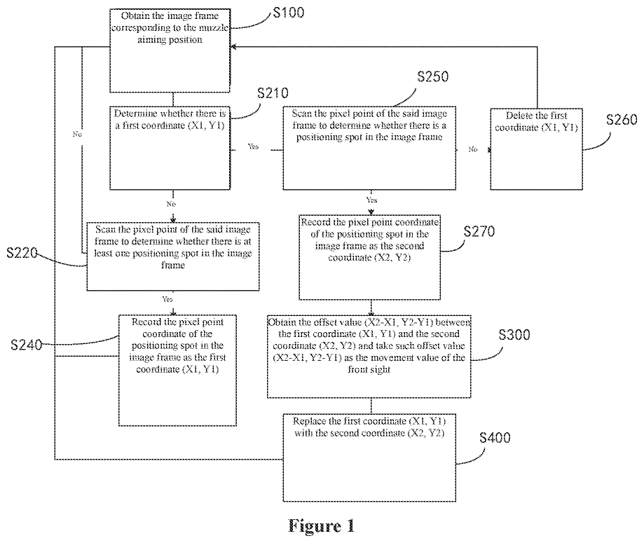

The front sight movement control method for shooting games in FIG. 1 includes the following steps:

S100: Obtain the image frame corresponding to the muzzle aiming position.

S200, including the following specific content:

S210: Determine whether there is a first coordinate (X1, Y1):

S220: if not, scan the pixel point of the said image frame to determine whether there is at least one positioning spot in the frame;

S230: If there is no positioning spot, proceed to S100;

S240: If there is a positioning spot, record the coordinate of the pixel point of the positioning spot in the image frame as the first coordinate (X1, Y1) and proceed to S100.

S250: If there is a first coordinate (X1, Y1), scan the pixel point of the said image frame to determine whether there is a positioning spot in the image frame;

S260: If not, delete the first coordinate (X1, Y1), then proceed to S100;

S270: If yes, record the pixel point coordinate of the positioning spot in the image frame as the second coordinate (X2, Y2).

S300: Obtain the offset value (X2−X1, Y2−Y1) between the first coordinate (X1, Y1) and the second coordinate (X2, Y2) and take the said offset value as the movement value of the front sight.

S400: Replace the first coordinate (X1, Y1) with the second coordinate (X2, Y2) and then proceed to S100.

Obtain the image frame corresponding to the muzzle aiming position to determine whether there is a first coordinate (X1, Y1), that is, whether the reference coordinate exists. If not, scan the pixel point of the said image frame to determine whether there is at least one positioning spot in the image frame. If yes, record the is coordinate of the pixel point of the positioning spot in the image frame as the first coordinate (X1, Y1), namely the reference coordinate and then back to S100. If not, proceed to S100 to obtain the first coordinate (X1, Y1) again as the reference coordinate. If the first coordinate (X1, Y1), namely the reference coordinate exists, scan the pixel point of the said image frame to determine whether there is a positioning spot in the image frame. If the positioning spot exists, record the coordinate of the pixel point of the positioning spot in the image frame as the second coordinate (X2, Y2) to obtain the moving coordinate, and then obtain the offset value (X2−X1, Y2−Y1) between the first coordinate (X1, Y1) and the second coordinate (X2, Y2). The offset value (X2−X1, Y2−Y1), namely the absolute movement value between the moving coordinate and the reference coordinate, could be used to obtain the movement value of the mouse (and the front sight), and then improve the sense of immersion and novelty of shooting games for users by aiming at the target through muzzle movement. The absence of positioning spot means the non-existence of moving coordinate and the unavailability of the absolute movement value between the moving coordinate and the reference coordinate, in this case, delete the first coordinate (X1, Y1) and then proceed to S100 to obtain the reference coordinate. At last, replace the first coordinate (X1, Y1) with the second coordinate (X2, Y2), proceed to S100, that is, take the moving coordinate as the reference coordinate, then obtain the new moving coordinate to get the absolute movement value between the new moving coordinate and the reference coordinate to ultimately realize continuous movement of front sight in the game.

In this embodiment, the movement value of the muzzle is translated to the movement of the mouse in order to replace the mouse with the light gun in target aiming for shooting games. To be specific, in this embodiment, a pixel coordinate axis is established based on the pixel point of the image frame, for example, for the 1280*800P resolution, the coordinate axis for the pixel point shall be established with the X and Y coordinate of 1280 and 800 respectively. The image frame could be obtained by the camera, while the positioning spot is produced while the camera captures a fixed lighting source. Therefore, the movement value of the muzzle could be determined based on the movement of the positioning spot in the image frame. In this embodiment, there shall be at least a fixed light source, and the movement value of the muzzle shall be obtained based on the pixel point coordinate of the corresponding positioning spot.

In this embodiment, the first coordinate (X1, Y1) and the second coordinate (X2, Y2) are obtained from two continuous image frame respectively, in order to ensure that the offset value (X2−X1, Y2−Y1) between the first coordinate (X1, Y1) and the second coordinate (X2, Y2) is real-time and continuous. Therefore, the first coordinate (X1, Y1) needs to be obtained again if failed to obtain the second coordinate (X2, Y2).

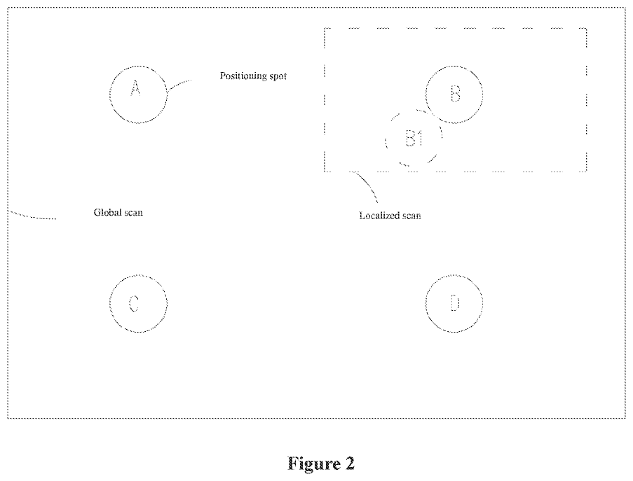

The specific step S250 as shown in FIG. 2, includes:

S251: If there is a first coordinate (X1, Y1), make a localized scan over the is pixel points of the image frame within the preset area around the first coordinate (X1, Y1) to determine whether there is a positioning spot in the preset area.

A, B, C and D are four positioning spots, of which the pixel point coordinate of B shall be taken as the first coordinate (X1, Y1), and for the image frame of the next frame where the position of B changes to B1, obtain B1 through localized scan around B, and take the pixel point coordinate of B1 as the second coordinate (X2, Y2). In this embodiment, as the first coordinate (X1, Y1) is taken as the reference coordinate, when the muzzle moves, the obtained positioning spot of the image frame tends to fall around the first coordinate (X1, Y1). Therefore, localized scan on the pixel point of the image frame shall be performed in the preset area around the first coordinate (X1, Y1). This method could reduce the data processing workload, shorten the response time, and further guarantee the correspondence between the offset value (X2−X1, Y2−Y1) and the muzzle movement by ensuring that both image frames capture the same positioning spot. Further, to ensure the localized scan could find the positioning spot, the camera shall capture the image frame at a rate of no less than 120 FPS in order to make the obtained image frame relatively continuous and produce a real-time transmission speed no less than that of the mouse—8 ms for improving the user's sense of immersion whiling playing shooting games. And the camera shall have a resolution of 1280*800 P to ensure that the movement of mouse will not produce too long frame intervals or zigzags. In addition, when there is only one positioning spot (lighting source), the preset area shall be a fixed default value, is for example, half the size of the entire image frame. When there are multiple positioning spots (lighting sources), the preset area shall be half of the distance between two positioning spots to ensure that only one positioning spot exists in the area. Further, when localized scan of an image frame confirms the existence of positioning spot and obtains the second coordinate (X2, Y2) and the offset value (X2−X1, Y2−Y1), then the localized scan of the next image frame shall use the same preset area, with the center moved according to the offset value instead of using the first coordinate (X1, Y1) as the center. For example, if the offset value (X2−X1, Y2−Y1) determines that the positioning spot is moving left, in order to scan it, the center of the preset area shall also move left by the preset value.

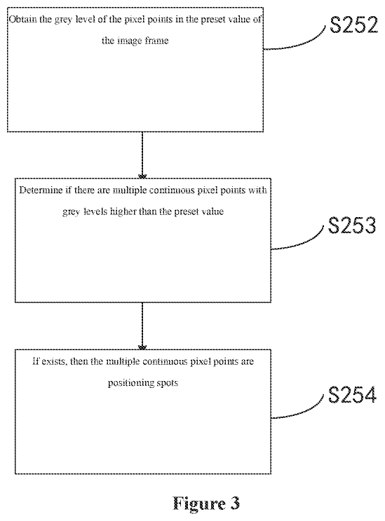

As details shown in FIG. 3, the steps determining if there is positioning spot in the preset area include:

S252: Obtain the grey level of pixel point in the preset area of the image frame.

S253: Determine if there are multiple pixel points of which the grey levels are higher than the preset levels.

S254: If yes, take the continuous pixel points as positioning spots.

In this embodiment, all the obtained image frame are RAW data of grey level display figures. Then scan the pixel points of the image frame from the left to the right and from the top to the bottom, and obtain the grey level corresponding to the pixel points. The positioning spot is produced by the lighting source—to be specific, is infrared light with the wavelength of 940 NM, and the capture of the infrared signals by the camera could produce the positioning spot. Therefore, the positioning spot has the highest grey level, and making the preset value slightly smaller than the maximum grey level could help determine whether a pixel point belongs to a positioning spot. A positioning spot has more than one pixel point, therefore, only the existence of multiple continuous (including both horizontally and vertically continuous) pixel points of which the grey levels are higher than the preset value could confirm such continuous pixel points as positioning spots.

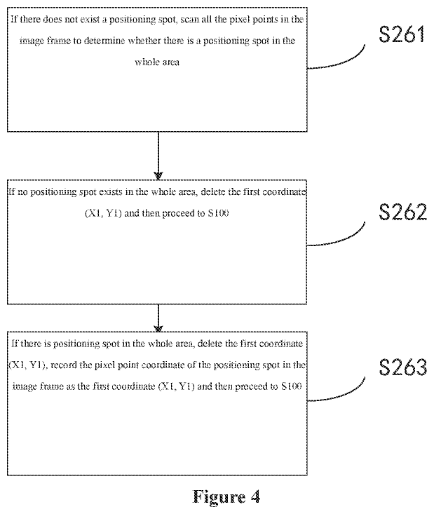

For more details, please refer to FIG. 4, and the said step S260 comprises:

S261: If there is no positioning spot, scan all the pixel points in entire image frame to determine if there is a positioning spot.

S262: If not, delete the first coordinate (X1, Y1), and proceed to S100.

S263: If yes, delete the first coordinate (X1, Y1), record the pixel point coordinate of the positioning spot in the image frame as the first coordinate (X1, Y1) and then proceed to S100.

If there is no positioning spot in the preset area around the first coordinate (X1, Y1), the second coordinate (X2, Y2), namely the moving coordinate corresponding to the reference coordinate, is unavailable, and the same is the absolute movement value between the moving coordinate and the reference coordinate. In this case, delete the first coordinate (X1, Y1), scan the entire image frame over which the localized scan was failed. If there is no positioning spot in the entire frame, delete the first coordinate (X1, Y1) and proceed to S100 to obtain the first coordinate (X1, Y1) again from the next image frame. If there is at least one positioning spot in the entire area, take the coordinate of the pixel point of the positioning spot as the first coordinate (X1, Y1), namely reconfirm the first coordinate instead of obtaining it from the next image frame. Furthermore, if no positioning spot exists in the entire area, input the revision information of the muzzle aiming target and remind the player to adjust the aiming, in order to guarantee the positioning spot will be captured in the next image frame.

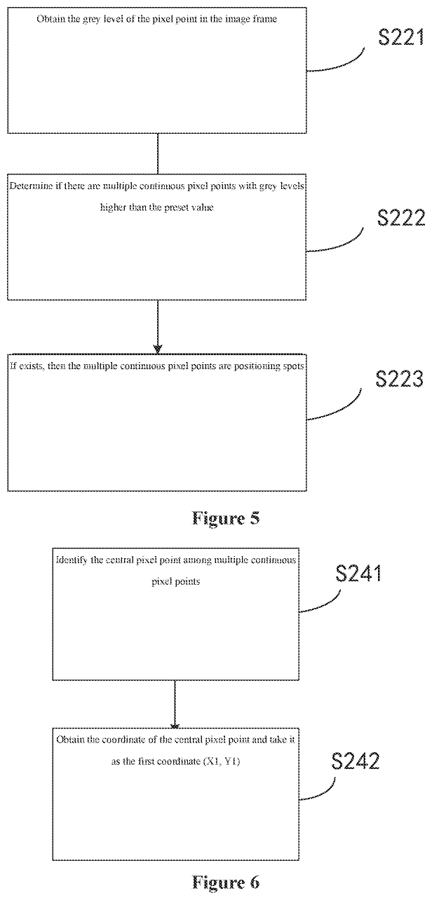

Refer to the details in FIG. 5, and as specified, S220 comprises:

S221: Obtain the grey level of pixel point in the image frame:

S222: Determine whether there are multiple continuous pixel points having grey levels higher than the preset one;

S223: If yes, take the continuous pixel points as positioning spots.

In this embodiment, all the obtained image frame are RAW data of grey level display figures. Then scan the pixel points of the image frame from the left to the right and from the top to the bottom, and obtain the grey level corresponding to the pixel points. The positioning spot is produced by the lighting source—to be specific, infrared light with the wavelength of 940 NM, and the capture of the infrared signals by the camera could produce the positioning spot. Therefore, the positioning spot has the highest grey level, and making the preset value slightly smaller than the maximum grey level could help determine whether a pixel point belongs to a positioning spot. A positioning spot has more than one pixel point, therefore, only the existence of multiple continuous (including both horizontally and vertically continuous) pixel points of which the grey levels are higher than the preset value could confirm such continuous pixel points as positioning spots.

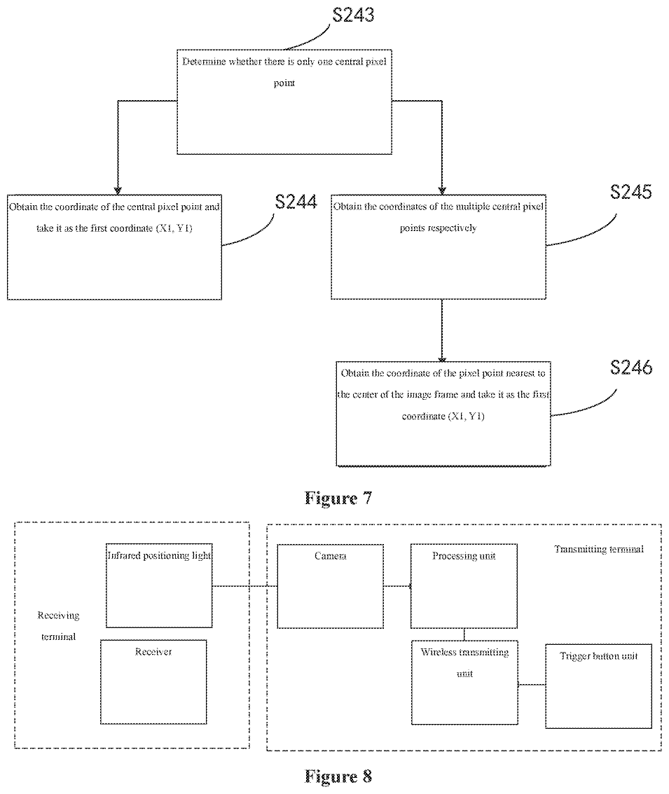

Refer to FIGS. 6 and 7 for the details, and the specified step S240 comprises:

S241: Identify the central pixel point among multiple continuous pixel points:

S242: Obtain the coordinate of the central pixel point and take it as the first coordinate (X1, Y1).

In this embodiment, the central pixel point comprises horizontal and vertical central positions of multiple pixel points.

The said step S242 further includes:

S243: Determine whether there is only one central pixel point:

S244: If yes, obtain the coordinate and take it as the first coordinate (X1, Y1);

S245: If not, obtain the coordinates of the multiple central pixel points respectively:

S246: Obtain the coordinate of the pixel point nearest to the center of the image frame and take it as the first coordinate (X1, Y1).

Multiple positioning spots in the image frame will produce multiple central pixel points, and among their coordinates, the one of the pixel point nearest to the center of the image frame shall be taken as the first coordinate (X1, Y1). Its closeness to the center of the image frame could probably fix the positioning spot in is the next image frame near the frame center.

In this embodiment, S220 also requires a global scan of the image frame, therefore S261 uses the same method for determining whether there is at least one positioning spot in the entire area as S220. While there are multiple positioning spot, S263 uses the same method for obtaining the coordinate of the central pixel point as S242.

The said S230 also includes:

S231: Output the revision information of the muzzle aiming position.

If no positioning spot exists, export the revision information of the muzzle aiming position to remind the user to adjust it, in order to ensure the positioning spot will be captured in the next image frame.

The method used to record the second coordinate (X2, Y2) in S270 is the same as that used in S240 for recording the first coordinate (X1, Y1).

In this embodiment, generally, the offset value (X2−X1, Y2−Y1), as the movement value of the front sight, shall be consistent with the pixel point of the front sight movement in the screen, that is, the displacement of the front sight shall be exactly equivalent to the offset value. Furthermore, the translation from offset value to the front sight movement could be adjusted proportionally to adjust the sensitivity of muzzle movement to suit various player needs.

As shown in FIG. 8, this embodiment also presents a front sight movement control device for shooting games comprising:

A transmitting terminal including the gun body, and the processing unit and wireless transmitting unit installed on the gun body. Camera is installed on the gun muzzle for obtaining the image frame of the aiming position and output the frame to the processing unit. The said processing unit stores and executes computer program in order to perform the above-mentioned front sight movement control method for shooting games, the said wireless transmitting unit is used output the movement value of the front sight.

The device also includes a trigger button unit, which comprises a processor for connecting with the wireless transmitting unit and buttons used for electrical connection with the processor. The processor is used to check if the button has been pressed, produce and output corresponding control signals to the wireless transmitting unit, which is also used to output the control signals. Control signals could be used to realize the shooting actions in the games.

The device also comprises the receiving terminal, including the receiver and at least one infrared positioning light. The said infrared positioning light is used to transmit infrared ray, to produce corresponding positioning spot on the image frame received by the camera, and the said receiver has a wireless receiving unit for receiving movement value of the front sight and output the value to the game console through the receiver. The infrared positioning light could be installed around the screen, this way, the receiver could output the front sight movement value and control signals received by the wireless receiving unit to the game is console through the USB interface for the game console to perform the front sight movement or shooting actions in the screen. Microprocessor could be used as the receiver.

This embodiment also proposes another storage medium where computer program is stored and executed by the processor to execute the above-mentioned front sight movement control method for shooting games.

It shall be noted in the last that, the above embodiments are only used to illustrate the technical scheme of this invention rather than constituting any limitation on the protection scope of this invention. And although this invention has been illustrated in details based on satisfactory embodiments, normal technical persons in this discipline shall understand that, the modification or equivalent replacement of the technical scheme in this invention shall still fall into the nature and scope of the technical scheme in this invention.

1. A front sight movement control method for shooting games, comprising the following steps:
S100: obtain the image frame corresponding to the muzzle aiming position;
S200: determine whether there is a first coordinate (X1, Y1):
if not, scan the pixel point of the said image frame to determine whether there is at least one positioning spot in the frame;
if there is no positioning spot, proceed to S100;
if positioning spot exists, record the coordinate of the positioning spot in the image frame as the first coordinate (X1, Y1) and proceed to S100;
if there is a first coordinate (X1, Y1), scan the pixel point of the said image frame to determine whether there is a positioning spot in the image frame;
if not, delete the first coordinate (X1, Y1), then proceed to S100;
if yes, record the pixel point coordinate of the positioning spot in the image frame as the second coordinate (X2, Y2);
S300: obtain the offset value (X2−X1, Y2−Y1) between the first coordinate (X1, Y1) and the second coordinate (X2, Y2) and take such offset value (X2−X1, Y2−Y1) as the movement value of the front sight;
S400: replace the first coordinate (X1, Y1) with the second coordinate (X2, Y2) and then proceed to S100.

2. The front sight movement control method for shooting games of claim 1, wherein, if there is a first coordinate (X1, Y1), the specific steps below shall be followed to scan the pixel point in the image frame in order to determine whether there is a positioning spot in the image frame:
if there is a first coordinate (X1, Y1), make a localized scan over the pixel points of the image frame within the preset area around the first coordinate (X1, Y1) to determine whether there is a positioning spot in the preset area.

3. The front sight movement control method for shooting games of claim 2, wherein, if there does not exist a positioning spot, the specific steps below shall be applicable to delete the first coordinate (X1, Y1) and then process to S100:
if there does not exist a positioning spot, scan all the pixel points in the image frame to determine whether there is a positioning spot in the whole area;
if not, delete the first coordinate (X1, Y1) and then proceed to S100;
if yes, delete the first coordinate (X1, Y1), record the pixel point coordinate of the positioning spot in the image frame as the first coordinate (X1, Y1) and then proceed to S100.

4. The front sight movement control method for shooting games of claim 2, wherein the specific steps below will be applied to determine whether there is a positioning spot in the preset area:
obtain the grey level of pixel point in the preset area of the image frame:
determine whether there are multiple continuous pixel points having grey levels higher than the preset one;
if yes, take the continuous pixel points as positioning spots.

5. The front sight movement control method for shooting games of claim 1, wherein, if there does not exist a first coordinate (X1, Y1), the specific steps below shall be followed to scan the pixel point in the image frame to determine whether there is at least one positioning spot in the image frame:
obtain the grey level of pixel point in the image frame:
determine whether there are multiple continuous pixel points having grey levels higher than the preset one;
if yes, take the continuous pixel points as positioning spots.

6. The front sight movement control method for shooting games of claim 5 wherein, if there is a positioning spot (X1, Y1), the specific steps below shall be followed to record the pixel point of the positioning spot in the image frame as the first coordinate (X1, Y1):
identify the central pixel point among multiple continuous pixel points:
obtain the coordinate of the central pixel point and take it as the first coordinate (X1, Y1).

7. The front sight movement control method for shooting games of claim 6, wherein the specific steps below shall be followed to obtain the coordinate of the central pixel point and take it as the first coordinate (X1, Y1):
determine whether there is only one central pixel point:
if yes, obtain the coordinate and take it as the first coordinate (X1, Y1);
if not, obtain the coordinates of the multiple central pixel points respectively:
obtain the coordinate of the pixel point nearest to the center of the image frame and take it as the first coordinate (X1, Y1).

8. A front sight movement control device for shooting games, comprising:
a transmitting terminal including the gun body, and the processing unit and wireless transmitting unit installed on the gun body, with camera installed on the gun muzzle for obtaining the image frame of the aiming position and output the frame to the processing unit;
the processing unit stores and executes computer program in order to perform the control method of claim 1;
the wireless transmitting unit is used output the movement value of the front sight.

9. The front sight movement control device for shooting games of claim 8, further comprising:
a receiving terminal, including a receiver and at least one infrared positioning light to produce positioning spot on the image frame received by the camera by transmitting infrared rays, and the said receiver has a wireless receiving unit for receiving movement value of the front sight and output the value to the game console through the receiver.

10. A storage medium for shooting games, wherein the computer program stored in the medium, while being executed by the processing unit, will perform the front sight movement control method of claim 1.
